(19) United States
(12) Patent Application Publication
(10) Pub. No.: US 2026/0163504 A1
(43) Pub. Date: Jun. 11, 2026

(54) MOTOR CONTROLLER

(71) Applicant: Global Mixed-mode Technology Inc., Hsin-Chu (TW)

(72) Inventor: Rong-Chin Lee, Pingtung County (TW)

(73) Assignee: Global Mixed-mode Technology Inc., Hsin-Chu (TW)

(21) Appl. No.: 18/974,811

(22) Filed: Dec. 10, 2024

(51) Int. Cl. H02P 6/15

(52) U.S. Cl. CPC H02P 6/153

(57) ABSTRACT

A motor controller comprises a switch circuit, a driving circuit, a pulse width modulation circuit, and a single Hall sensor. The single Hall sensor is coupled to the pulse width modulation circuit for generating a Hall signal. The Hall signal generates a first time and the motor controller records the first time. After the first time elapses, the motor controller utilizes the recorded first time to drive a first driving signal, such that the first driving signal has a first driving time and the first driving time is equal to the first time. The motor controller is configured to reduce noise and decrease the cost.

### BACKGROUND OF THE INVENTION

### 1. Field of the Invention

The present invention relates to a motor controller, and more particularly, to a motor controller which is capable of driving a three-phase motor by a single Hall sensor.

### 2. Description of the Prior Art

Conventionally, there are two driving methods for driving a three-phase motor. The first driving method uses the Hall sensor for switching phases, so as to drive the three-phase motor. The second driving method does not use the Hall sensor to drive the three-phase motor. In early days it is common to use three Hall sensors to drive the three-phase motor. However, if the three Hall sensors are placed at an asymmetric angle to each other, the driving waveform will be deformed and noise will be generated. In addition, configuring three Hall sensors to drive the three-phase motor increases the cost, too.

Thus, a new three-phase motor driving technology is needed to reduce noise and decrease the cost.

### SUMMARY OF THE INVENTION

According to one embodiment of the present invention, a motor controller which is capable of driving a three-phase motor by a single Hall sensor is provided. The motor controller is configured to reduce noise. The motor controller is configured to drive the three-phase motor, where the three-phase motor has a first coil, a second coil, and a third coil. The motor controller comprises a switch circuit, a driving circuit, a pulse width modulation circuit, and a single Hall sensor. The switch circuit is coupled to the three-phase motor for driving the three-phase motor. The switch circuit comprises a first transistor, a second transistor, a third transistor, a fourth transistor, a fifth transistor, a sixth transistor, a first terminal, a second terminal, a third terminal, a fourth terminal, and a fifth terminal. The first transistor is coupled to the first terminal and the fourth terminal. The second transistor is coupled to the first terminal and the fifth terminal. The third transistor is coupled to the second terminal and the fourth terminal. The fourth transistor is coupled to the second terminal and the fifth terminal. The fifth transistor is coupled to the third terminal and the fourth terminal. The sixth transistor is coupled to the third terminal and the fifth terminal. The first terminal provides a first driving signal for driving the three-phase motor. A waveform of the first driving signal is similar to an M-shaped waveform. The driving circuit is configured to generate a plurality of control signals to control the switch circuit. The pulse width modulation circuit is configured to generate a pulse width modulation signal to the driving circuit. The single Hall sensor is configured to generate a Hall signal to the pulse width modulation circuit.

According to one embodiment of the present invention, the Hall signal generates a first time and the motor controller records the first time. After the first time elapses, the motor controller utilizes the recorded first time to drive the first driving signal, such that the first driving signal has a first driving time and the first driving time is equal to the first time.

According to one embodiment of the present invention, the Hall signal generates the first time and a second time, the motor controller records the first time and the second time. After the second time elapses, the motor controller utilizes the recorded first time and the recorded second time to drive the first driving signal, such that the first driving signal has a first driving time and the first driving time is equal to (the first time+the second time)/2.

To sum up, the Hall signal generates the first time and the motor controller records the first time. After the first time elapses, the motor controller utilizes the recorded first time to drive the first driving signal, such that the first driving signal has a first driving time and the first driving time is related to the first time. The motor controller may utilize an average concept to drive the three-phase motor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a motor controller according to one embodiment of the present invention;

FIG. 2 is a first timing chart according to one embodiment of the present invention; and

FIG. 3 is a second timing chart according to one embodiment of the present invention.

### DETAILED DESCRIPTION

Preferred embodiments according to the present invention will be described in detail with reference to the drawings.

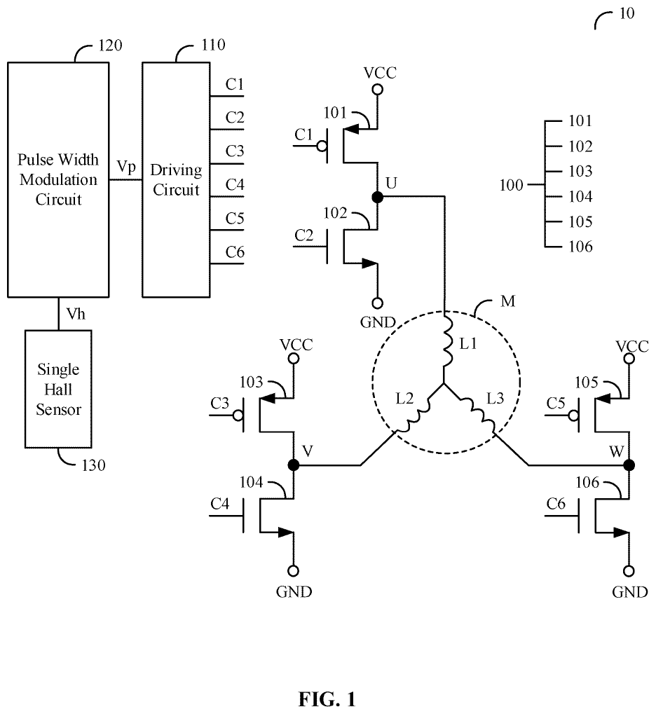

FIG. 1 is a circuit diagram showing a motor controller 10 according to one embodiment of the present invention. The motor controller 10 is used for driving a three-phase motor M, where the three-phase motor M has a first coil L1, a second coil L2, and a third coil L3. The motor controller 10 comprises a switch circuit 100, a driving circuit 110, a pulse width modulation circuit 120, and a single Hall sensor 130. The switch circuit 100 includes a first transistor 101, a second transistor 102, a third transistor 103, a fourth transistor 104, a fifth transistor 105, a sixth transistor 106, a first terminal U, a second terminal V, a third terminal W, a fourth terminal VCC, and a fifth terminal GND, where the switch circuit 100 is coupled to the three-phase motor M for driving the three-phase motor M. The first terminal U, the second terminal V, and the third terminal W respectively provides a first driving signal Su, a second driving signal Sv, and the third driving signal Sw for driving the three-phase motor M. In addition, each of the waveform of the first driving signal Su, the waveform of the second driving signal Sv, and the waveform of the third driving signal Sw may be similar to an M-shaped waveform. The first transistor 101 is coupled to the first terminal U and the fourth terminal VCC while the second transistor 102 is coupled to the first terminal U and the fifth terminal GND. The third transistor 103 is coupled to the second terminal V and the fourth terminal VCC while the fourth transistor 104 is coupled to the second terminal V and the fifth terminal GND. The fifth transistor 105 is coupled to the third terminal W and the fourth terminal VCC while the sixth transistor 106 is coupled to the third terminal W and the fifth terminal GND. Each of the first transistor 101, the third transistor 103, and the fifth transistor 105 may be a p-type MOSFET. Each of the second transistor 102, the fourth transistor 104, and the sixth transistor 106 may be an n-type MOSFET.

One terminal of the first coil L1 is coupled to the first terminal U. One terminal of the second coil L2 is coupled to the second terminal V. One terminal of the third coil L3 is coupled to the third terminal W. Furthermore, another terminal of the first coil L1 is coupled to another terminal of the second coil L2 and another terminal of the third coil L3. That is to say, the first coil L1, the second coil L2, and the third coil L3 form a Y-shaped configuration. The driving circuit 110 generates a first control signal C1, a second control signal C2, a third control signal C3, a fourth control signal C4, a fifth control signal C5, and a sixth control signal C6 for respectively controlling the ON/OFF states of the first transistor 101, the second transistor 102, the third transistor 103, the fourth transistor 104, the fifth transistor 105, and the sixth transistor 106. The pulse width modulation circuit 120 generates a pulse width modulation signal Vp to the driving circuit 110, where the pulse width modulation signal Vp is used for adjusting the speed of the three-phase motor M. The single Hall sensor 130 is coupled to the pulse width modulation circuit 120, so as to detect a magnetic pole position of the three-phase motor M and generate a Hall signal Vh to the pulse width modulation circuit 120 for switching phases. Since people of ordinary skill in the technology field should realize the method to drive the three-phase motor M, the detailed description is omitted.

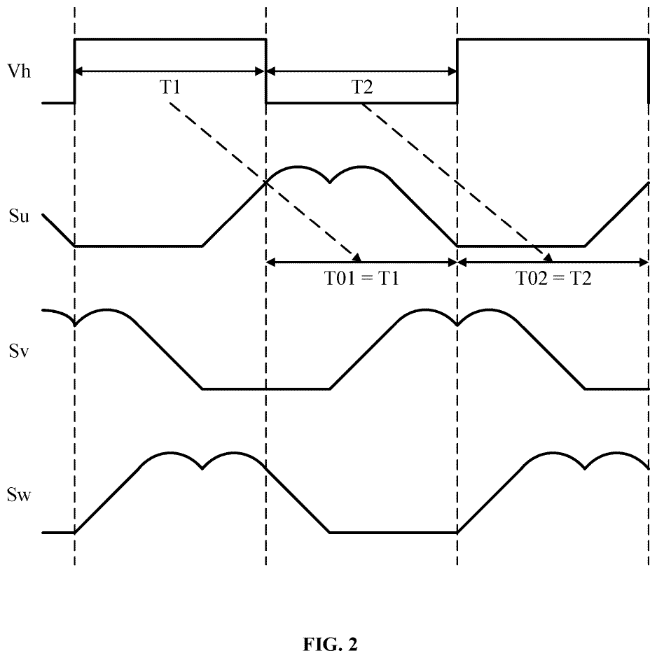

In order to solve the drawbacks of the prior-art technology, the motor controller 10 of the present invention simply utilizes the single Hall sensor 130 to drive the three-phase motor M. FIG. 2 is a first timing chart according to one embodiment of the present invention. The Hall signal Vh may generate a first time T1 and the motor controller 10 records the first time T1, where the first time T1 may represent a first 180-degree electric angle time. After the first time T1 elapses, the motor controller 10 utilizes the recorded first time T1 to drive the first driving signal Su, such that the first driving signal Su may have a first driving time T01 and the first driving time T01 may be equal to the first time T1. The Hall signal Vh may further generate a second time T2 and the motor controller 10 records the second time T2, where the second time T2 may represent a second 180-degree electric angle time. After the second time T2 elapses, the motor controller 10 utilizes the recorded second time T2 to drive the first driving signal Su, such that the first driving signal Su may have a second driving time T02 and the second driving time T02 may be equal to the second time T2. According to this rule and so on, this three-phase motor drive method may reduce noise and decrease the cost. In addition, this three-phase motor drive method enables the driving waveforms to be more accurate.

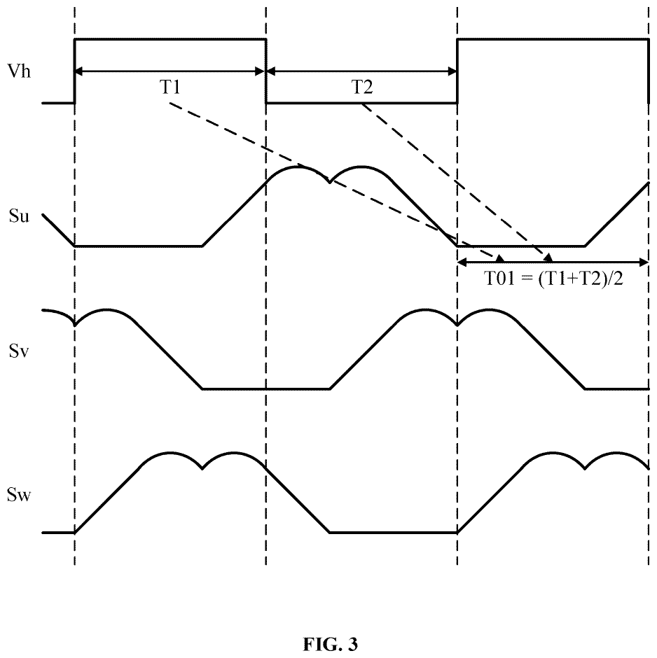

FIG. 3 is a second timing chart according to one embodiment of the present invention. The Hall signal Vh may generate the first time T1 and the second time T2. Then the motor controller 10 records the first time T1 and the second time T2, where the first time T1 may represent the first 180-degree electric angle time and the second time T2 may represent the second 180-degree electric angle time. After the second time T2 elapses, the motor controller 10 utilizes the recorded first time T1 and the recorded second time T2 to drive the first driving signal Su, such that the first driving signal Su may have the first driving time T01 and the first driving time T01 may be equal to (the first time T1+the second time T2)/2. In other words, the motor controller 10 utilizes an average concept to drive the three-phase motor M. According to this rule and so on, this three-phase motor drive method may reduce noise and decrease the cost. In addition, this three-phase motor drive method enables the driving waveforms to be more accurate.

To sum up, the Hall signal Vh may generate the first time T1 and the motor controller 10 records the first time T1, where the first time T1 may represent the first 180-degree electric angle time. After the first time T1 elapses, the motor controller 10 utilizes the recorded first time T1 to drive the first driving signal Su, such that the first driving signal Su may have the first driving time T01 and the first driving time T01 may be related to the first time T1. The Hall signal Vh may further generate the second time T2 and the motor controller 10 records the second time T2, where the second time T2 may represent the second 180-degree electric angle time. After the second time T2 elapses, the motor controller 10 utilizes the recorded second time T2 to drive the first driving signal Su, such that the first driving signal Su may have the second driving time T02 and the second driving time T02 may be related to the second time T2. According to this rule and so on, this three-phase motor drive method may reduce noise and decrease the cost. In addition, this three-phase motor drive method enables the driving waveforms to be more accurate. The motor controller 10 may utilize the average concept to drive the three-phase motor M, too.

The motor controller 10 of the present invention may be applied to a cooling fan. Also, the motor controller 10 of the present invention may be applied to a home appliance system. By configuring the single Hall sensor 130, the motor controller 10 may reduce noise and decrease the cost.

While the present invention has been described by the preferred embodiments, it is to be understood that the invention is not limited to the disclosed embodiments. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller configured to drive a three-phase motor, wherein the three-phase motor has a first coil, a second coil, and a third coil, and the motor controller comprises:
a switch circuit, coupled to the three-phase motor, wherein the switch circuit comprises a first transistor, a second transistor, a third transistor, a fourth transistor, a fifth transistor, a sixth transistor, a first terminal, a second terminal, a third terminal, a fourth terminal, and a fifth terminal, the first transistor is coupled to the first terminal and the fourth terminal, the second transistor is coupled to the first terminal and the fifth terminal, the third transistor is coupled to the second terminal and the fourth terminal, the fourth transistor is coupled to the second terminal and the fifth terminal, the fifth transistor is coupled to the third terminal and the fourth terminal, the sixth transistor is coupled to the third terminal and the fifth terminal, and the first terminal provides a first driving signal for driving the three-phase motor;
a driving circuit, configured to generate a plurality of control signals to control the switch circuit;
a pulse width modulation circuit, configured to generate a pulse width modulation signal to the driving circuit; and
a single Hall sensor, configured to generate a Hall signal to the pulse width modulation circuit, wherein the Hall signal generates a first time and the motor controller records the first time, and after the first time elapses, the motor controller utilizes the recorded first time to drive the first driving signal, such that the first driving signal has a first driving time and the first driving time is equal to the first time.

2. The motor controller of claim 1, wherein a waveform of the first driving signal is similar to an M-shaped waveform.

3. The motor controller of claim 1, wherein the first time represents a first 180-degree electric angle time.

4. The motor controller of claim 1, wherein a terminal of the first coil is coupled to the first terminal, a terminal of the second coil is coupled to the second terminal, and a terminal of the third coil is coupled to the third terminal.

5. The motor controller of claim 1, wherein the Hall signal further generates a second time and the motor controller records the second time, and after the second time elapses, the motor controller utilizes the recorded second time to drive the first driving signal, such that the first driving signal has a second driving time and the second driving time is equal to the second time.

6. The motor controller of claim 5, wherein the second time represents a second 180-degree electric angle time.

7. The motor controller of claim 1, wherein the motor controller is applied to a cooling fan.

8. The motor controller of claim 1, wherein the motor controller is applied to a home appliance system.

9. The motor controller of claim 1, wherein the motor controller is configured to reduce noise.

10. A motor controller configured to drive a three-phase motor,
wherein the three-phase motor has a first coil, a second coil, and a third coil, and the motor controller comprises:
a switch circuit, coupled to the three-phase motor, wherein the switch circuit comprises a first transistor, a second transistor, a third transistor, a fourth transistor, a fifth transistor, a sixth transistor, a first terminal, a second terminal, a third terminal, a fourth terminal, and a fifth terminal, the first transistor is coupled to the first terminal and the fourth terminal, the second transistor is coupled to the first terminal and the fifth terminal, the third transistor is coupled to the second terminal and the fourth terminal, the fourth transistor is coupled to the second terminal and the fifth terminal, the fifth transistor is coupled to the third terminal and the fourth terminal, the sixth transistor is coupled to the third terminal and the fifth terminal, and the first terminal provides a first driving signal for driving the three-phase motor;
a driving circuit, configured to generate a plurality of control signals to control the switch circuit;
a pulse width modulation circuit, configured to generate a pulse width modulation signal to the driving circuit; and
a single Hall sensor, configured to generate a Hall signal to the pulse width modulation circuit, wherein the Hall signal generates a first time and a second time, the motor controller records the first time and the second time, and after the second time elapses, the motor controller utilizes the recorded first time and the recorded second time to drive the first driving signal, such that the first driving signal has a first driving time and the first driving time is equal to (the first time +the second time)/2.

11. The motor controller of claim 10, wherein a waveform of the first driving signal is similar to an M-shaped waveform.

12. The motor controller of claim 10, wherein the first time represents a first 180-degree electric angle time and the second time represents a second 180-degree electric angle time.

13. The motor controller of claim 10, wherein a terminal of the first coil is coupled to the first terminal, a terminal of the second coil is coupled to the second terminal, and a terminal of the third coil is coupled to the third terminal.

14. The motor controller of claim 10, wherein the motor controller is applied to a cooling fan.

15. The motor controller of claim 10, wherein the motor controller is applied to a home appliance system.

16. The motor controller of claim 10, wherein the motor controller is configured to reduce noise.

17. A motor controller configured to drive a three-phase motor,
wherein the three-phase motor has a first coil, a second coil, and a third coil, and the motor controller comprises:
a switch circuit, coupled to the three-phase motor, wherein the switch circuit comprises a first transistor, a second transistor, a third transistor, a fourth transistor, a fifth transistor, a sixth transistor, a first terminal, a second terminal, a third terminal, a fourth terminal, and a fifth terminal, the first transistor is coupled to the first terminal and the fourth terminal, the second transistor is coupled to the first terminal and the fifth terminal, the third transistor is coupled to the second terminal and the fourth terminal, the fourth transistor is coupled to the second terminal and the fifth terminal, the fifth transistor is coupled to the third terminal and the fourth terminal, the sixth transistor is coupled to the third terminal and the fifth terminal, and the first terminal provides a first driving signal for driving the three-phase motor;
a driving circuit, configured to generate a plurality of control signals to control the switch circuit;
a pulse width modulation circuit, configured to generate a pulse width modulation signal to the driving circuit; and
a single Hall sensor, configured to generate a Hall signal to the pulse width modulation circuit, wherein the Hall signal generates a first time and the motor controller records the first time, and after the first time elapses, the motor controller utilizes the recorded first time to drive the first driving signal, such that the first driving signal has a first driving time and the first driving time is related to the first time.

18. The motor controller of claim 17, wherein a waveform of the first driving signal is similar to an M-shaped waveform.

19. The motor controller of claim 17, wherein the first time represents a first 180-degree electric angle time.

20. The motor controller of claim 17, wherein a terminal of the first coil is coupled to the first terminal, a terminal of the second coil is coupled to the second terminal, and a terminal of the third coil is coupled to the third terminal.

21. The motor controller of claim 17, wherein the Hall signal further generates a second time and the motor controller records the second time, and after the second time elapses, the motor controller utilizes the recorded second time to drive the first driving signal, such that the first driving signal has a second driving time and the second driving time is related to the second time.

22. The motor controller of claim 21, wherein the second time represents a second 180-degree electric angle time.

23. The motor controller of claim 17, wherein the motor controller utilizes an average concept to drive the three-phase motor.

24. The motor controller of claim 17, wherein the motor controller is applied to a cooling fan.

25. The motor controller of claim 17, wherein the motor controller is applied to a home appliance system.

26. The motor controller of claim 17, wherein the motor controller is configured to reduce noise.
